(19) United States
(12) Patent Application Publication
(10) Pub. No.: US 2026/0135153 A1
(43) Pub. Date: May 14, 2026

(54) ELECTROLYTE COMPOSITION FOR A LITHIUM-ION BATTERY

(71) Applicant: Energy Battery Tech, Inc., Tulsa, OK (US)

(72) Inventors: Ahmad Amiri, Tulsa, OK (US); Andreas A. Polycarpou, Tulsa, OK (US)

(73) Assignee: Energy Battery Tech, Inc., Tulsa, OK (US)

(21) Appl. No.: 19/383,667

(22) Filed: Nov. 9, 2025

Related U.S. Application Data
(60) Provisional application No. 63/719,169, filed on Nov. 12, 2024.

(51) Int. Cl. H01M 10/0569; H01M 10/0525; H01M 10/0567; H01M 10/0568

(52) U.S. Cl. CPC H01M 10/0569; H01M 10/0525; H01M 10/0567; H01M 10/0568; H01M 2300/0037; H01M 2300/008; H01M 2300/0091

(57) ABSTRACT

A lithium-ion battery electrolyte is disclosed that enables reversible lithiation and delithiation from +50° C. down to −80° C. The electrolyte is a dual-solvent system of 1,3-dioxolane and butyronitrile formulated to balance donor strength and desolvation energy, creating a solvent-separated-ion-pair-rich solvation shell with very low Li⁺ transport activation energy. This tailored solvation promotes formation of a thin, mechanically elastic solid-electrolyte/inter-electrolyte interphase containing LiF, Li₃N, and polymeric ether domains derived from the solvents and additive salts. The resulting interphase provides high ionic conductivity and chemical robustness while minimizing impedance growth. Electrochemical testing demonstrates stable cycling for over 50 cycles at temperatures from −80° C. to +50° C. with high coulombic efficiency. The invention establishes a coupled solvation-interphase design principle that decouples ionic mobility from interfacial stability, enabling reliable cryogenic operation and providing a predictive framework for next-generation low-temperature lithium-ion battery electrolytes.

### CROSS REFERENCE TO RELATED APPLICATION

This application claims priority to U.S. Provisional Application 63/719,169 filed Nov. 12, 2024.

### BACKGROUND OF THE INVENTION

Lithium-ion batteries (LIBs) are the foundational energy storage technology for a wide array of applications ranging from portable electronics to electric vehicles and space technologies. Their dominance stems from a combination of high energy density, long cycle life, and low self-discharge. However, despite their widespread success, current LIB technologies exhibit a sharp performance decline under extremely low-temperature conditions^{6,7}. This limitation presents a formidable challenge for the deployment of LIBs in high-latitude environments, aerospace systems, and deep-space exploration, where sub-zero and even cryogenic temperatures are routine.

At extremely low temperatures (e.g., −50° C. to −100° C.), the lithiation/delithiation process is significantly limited in the presence of various types of anodes. This degradation arises from a convergence of physicochemical bottlenecks: (1) reduced ionic conductivity in the bulk electrolyte due to increased viscosity and diminished salt dissociation, (2) slow Li⁺ diffusion across electrode interfaces and through the solid electrolyte interphase (SEI) and cathode electrolyte interphase (CEI), and (3) high desolvation energy barriers that impede interfacial charge transfer. These challenges compound over cycles, accelerating lithium plating, dead lithium formation, and irreversible capacity loss. Complicating matters further, electrode materials undergo crystallographic phase transitions and mechanical degradation during repeated lithiation/delithiation, especially under thermally stressed conditions. As a result, the operational stability of LIBs at ultra-low temperatures (ULTs) is fundamentally governed by the interplay between electrolyte solvation structure and interfacial reaction kinetics.

Among the critical factors contributing to low-temperature failure, electrolyte plays the most significant role. Traditional carbonate-based electrolytes, particularly those containing ethylene carbonate (EC), become highly viscous or even solidify below −20° C., rendering Li⁺ transport virtually impossible. Furthermore, their strong Li⁺ coordination impedes desolvation at the electrode interface—an essential step in charge transfer. These drawbacks have shifted attention toward solvents with intrinsically weaker Li⁺ coordination and lower viscosity, such as ethers, acetates, and nitriles.

Among these, ethers and nitriles have emerged as the most promising families of solvents for low-temperature battery applications. Ether-based solvents—such as 1,3-dioxolane (DOL), tetrahydrofuran (THF), and dimethoxyethane (DME)—exhibit exceptionally low freezing points (often below −100° C.), low viscosity, and weak Li⁺ solvation strength. Importantly, some cyclic ethers (e.g., DOL and THF) undergo ring-opening reactions at the interfaces, forming polymeric S/CEI structures that are mechanically robust and resistant to cracking during cycle-induced thermal shocks¹⁸. However, the low dielectric constants of ether solvents limit salt dissociation and result in lower concentrations of free Li⁺ ions, while their tendency to co-intercalate into graphite poses a serious risk of anode degradation.

Conversely, nitrile solvents such as butyronitrile (BN), acetonitrile (AN), and isobutyronitrile (iBN) offer complementary advantages. Nitriles have high dielectric constants and low viscosity, enabling superior salt dissociation and bulk ionic conductivity even at temperatures below −70° C. Furthermore, nitrile-based electrolytes promote the formation of SEI layers rich in lithium nitrides (e.g., Li₃N), which are known to possess high ionic conductivity—traits that are especially desirable at low temperatures. However, nitriles suffer from poor reductive stability and are prone to decomposition on graphite anodes, which prevents the formation of stable, passivating SEI layers.

To date, most attempts to engineer low-temperature electrolytes have employed either ether- or nitrile-based systems independently. While several studies have demonstrated charge-discharge capability down to −40° C. or even −60° C. using different solvent systems (a combination of weakly and strong solvating solvents), reliable and reversible lithiation/delithiation below −80° C. has not been reported. This temperature range remains a technological barrier for missions in deep space, polar research, and aviation applications at high altitudes, where energy storage systems must remain operational under cryogenic conditions.

There are several key interdependent parameters (Prior Art FIG. 1) that must be simultaneously optimized to enable stable lithiation and delithiation at −80° C., 100. Achieving this extreme low-temperature performance is not possible by adjusting any single parameter in isolation; rather, all factors must be co-engineered in a balanced manner. At the core lies the SEI, which must be extremely thin yet chemically robust. A functional SEI should incorporate LiF, Li₃N, and polymeric components, providing both elastic mechanical behavior (to avoid formation of crack in interphase) and efficient ionic transport pathways. Excessive SEI thickening or continuous growth is detrimental, as it introduces resistive barriers that dramatically suppress Li⁺ transport across both the SEI and CEI layers. Moreover, the polymeric characteristics of the SEI, while beneficial for elasticity, can impede ion transport at high C-rates if not carefully balanced. Hence, the SEI composition, morphology, and kinetics must be precisely tuned alongside other electrolyte properties—including solvation structure, ionic transport, ion association, and dielectric response. It should be mentioned that the relationship between SEI thickness and electrochemical performance is inherently non-linear, presenting distinct challenges at different operating temperatures. At room temperature (25° C.) thicker SEI layers generally improve cycle stability by providing enhanced protection against continuous electrolyte decomposition. However, this benefit comes at the expense of low-temperature performance at −80° C., excessively thick SEI layers act as strong diffusion barriers, severely limiting Li⁺ transport and resulting in rapid performance degradation. Conversely, ultrathin SEI films, while favorable for ion transport, are mechanically unstable and prone to cracking, which accelerates electrolyte exposure and capacity fading at 25° C. Therefore, only a moderate SEI thickness—engineered with the appropriate chemical composition (LiF (good protection), Li₃N (good ionic conductivity), and polymeric elastic domains)—can simultaneously balance room-temperature stability with cryogenic ion conductivity.

### SUMMARY OF THE INVENTION

In this work, we introduce a novel electrolyte strategy that unites the low-temperature advantages of both ether and nitrile families to push the operational limits of LIBs toward −80° C., and beyond (FIG. 1). The first central hypothesis of this study is that combining a weakly coordinating ether (DOL) and a weakly coordinating nitrile (BN)—both with ultra-low freezing points and closely matched Li⁺ desolvation energies—can result in a finely tuned solvation structure that enables high ionic conductivity, low interfacial resistance, and stable SEI/CEI formation at cryogenic temperatures. This dual-solvent approach aims to overcome the longstanding trade-off between ionic mobility and interfacial stability by engineering a solvation shell in which both solvents co-exist and cooperate, rather than compete, in coordinating Li⁺ ions. This electrolyte intrinsically suppresses SEI/CEI thickening; to further stabilize the interphase, we employed tris(trimethylsilyl)phosphite (TMSP) and fluoroethylene carbonate (FEC) to pre-form a thin artificial SEI/CEI layer. This engineered interphase remains thin yet robust, minimizing continued electrolyte decomposition and protecting the bulk electrolyte from prolonged exposure.

Enabling reversible lithiation and delithiation at −80° C. lithium-ion batteries (LIBs) require the simultaneous optimization of solvation structure, ion transport, dielectric response, and SEI/CEI chemistry—where the interphase must be thin yet chemically robust, incorporating LiF, Li₃N, and polymeric elastic domains at a moderate thickness to balance room-temperature stability with cryogenic ionic conductivity. To this end, we report a transformative electrolyte strategy that enables full lithiation/delithiation cycling of LIBs at −80° C. Our approach combines a weakly coordinating ether, 1,3-dioxolane (DOL), with a high-dielectric nitrile, butyronitrile (BN), to create a dual-solvent electrolyte with uniquely balanced desolvation energetics. Unlike prior systems, where solvent asymmetry leads to unstable solvation shells and poor interfacial kinetics, we show—using Raman spectroscopy—that DOL and BN co-occupy the Li⁺ primary solvation shell, forming a solvent-separated-ion-pair (SSIP)-rich environment with an exceptionally low activation energy for Li⁺ transport (˜3.35 kJ mol⁻¹). This tailored solvation structure enables the formation of a hybrid SEI/CEI composed of polymeric ethers (from DOL), Li₃N (from BN), and LiF (from FEC and LiTFSI), providing both mechanical elasticity and high ionic conductivity at low temperatures. Electrochemical testing confirms stable cycling at a broad temperature range of −80° C. to 50° C. for over 50 cycles with minimal impedance growth and high coulombic efficiency. The novelty of this work lies in the establishment of a coupled solvation-interphase design principle: by matching donor strength and desolvation energy across distinct solvent families while initiating a thin artificial SEI with TMSP, we decouple the traditional trade-off between ionic mobility and interfacial stability, ensuring cryogenic ion transport, room-temperature durability, and suppression of SEI/CEI thickening that would otherwise degrade capacity during −80° C. cycling. This study not only introduces a high-performance electrolyte for ultra-low-temperature batteries but also generates fundamental insights into solvation-shell engineering, interphase chemistry, and electrolyte/interphase structures-function relationships. These findings offer a predictive framework for designing next-generation electrolytes and set the foundation for reliable LIB operation across a wide temperature range—from +50° C. to −80° C.

### BRIEF DESCRIPTION OF THE FIGURES

The patent or application file contains as least one drawing executed in color. Copies of this patent or patent application publication with color drawing(s) will be provided by the Office upon request and payment of the necessary fee.

FIG. 1 (PRIOR ART) Interdependent parameters governing SEI structure and electrolyte properties;

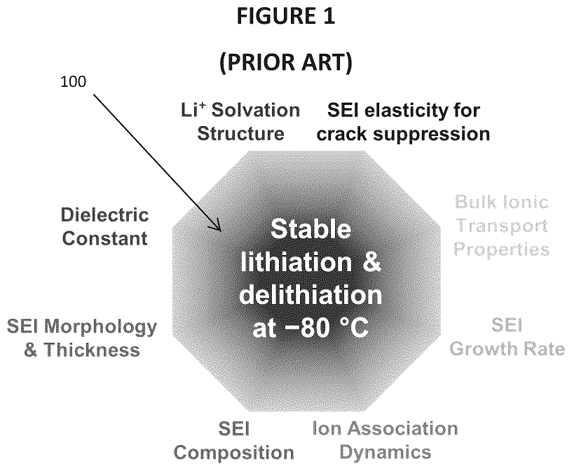

FIG. 2 Schematic illustration of engineering dual solvent systems comprising BN and DOL;

FIG. 3A-E. Decomposition of Li⁺ solvation environments into SSIP, CIP, AGG, and non-aggregated species (n-AGG);

FIG. 4. Raman spectra of different electrolytes composed of different BN-DOL ratio.

FIG. 5. Raman spectra for selected electrolyte systems

FIG. 6. Raman spectra for selected electrolyte systems

FIG. 7. Raman spectra focusing on the region (2050-2350 cm⁻¹) for different electrolyte combinations;

FIG. 8. GCD profiles of LiNMC111/Graphite full cells at 25° C. with different ratio of DOL and BN in 1M LiTFSI+10% FEC electrolyte;

FIG. 9 GCD profiles of LiNMC111/Graphite full cells at −80° C. with different ratio of DOL and BN in 1M LiTFSI+10% FEC electrolyte;

FIG. 10 GCD profiles of LiNMC111/Graphite full cells at 25° C. with different ratio of FEC in the 54% BN+36% DOL+1M LiTFSI electrolyte;

FIG. 11 GCD profiles of LiNMC111/Graphite cells with electrolyte composed of 54% BN+36% DOL+10% FEC+1M LiTFSI electrolyte at −80° C.

FIG. 12 GCD profiles of LiNMC111/Graphite full cells at 25° C. with different concentrations of TMSP additive in the 54% BN+36% DOL+1M LiTFSI electrolyte

FIG. 13A-K. Galvanostatic charge/discharge (GCD) profiles for full cells with our electrolyte;

FIG. 14 Discharge capacities of LiNMC111/Graphite full cells at 25° C. with different ratio of THF and BN in 1M LiTFSI+10% FEC and 54% BN+36% DOL+10% FEC+1M LiTFSI electrolyte

FIG. 15 Discharge capacities of LiNMC111/Graphite full cells at −80° C. with different ratio of THF and BN in 1M LiTFSI+10% FEC and 54% BN+36% DOL+10% FEC+1M LiTFSI electrolyte

FIG. 16 Comparison of discharge capacities of 54% BN+36% DOL+10% FEC+1M LiTFSI and 45% BN+45% MTHF+10% FEC+1M LiTFSI electrolytes at 25° C.

FIG. 17 Comparison of discharge capacities of 54% BN+36% DOL+10% FEC+1M LiTFSI and 45% BN+45% MTHF+10% FEC+1M LiTFSI electrolytes at −80° C.

FIG. 18 Comparison of discharge capacities of 54% BN+36% DOL+10% FEC+1M LiTFSI and 18% BN+72% DGDE+10% FEC+1M LiTFSI electrolytes at 25° C.

FIG. 19 Comparison of discharge capacities of 54% BN+36% DOL+10% FEC+1M LiTFSI and 18% BN+72% DGDE+10% FEC+1M LiTFSI electrolytes at −80° C.

FIG. 20A-K. post cycling characterization on our electrodes;

FIG. 21 XPS spectra of the P 2s and P 2p regions for graphite electrodes before and after cycling at different temperatures.

FIG. 22 XPS spectra of the cathode surface after cycling at 25° C.

FIG. 23 XPS spectra of the cathode surface after cycling at 25° C.

FIG. 24 XPS spectra of the cathode surface after cycling at 25° C.

FIG. 25 XPS spectra of the cathode surface after cycling at 25° C.

FIG. 26 XPS spectra of the cathode surface after cycling at 25° C.

FIG. 27 XPS spectra of the cathode surface after cycling at −80° C.

FIG. 28 XPS spectra of the cathode surface after cycling at −80° C.

FIG. 29 XPS spectra of the cathode surface after cycling at −80° C.

FIG. 30 XPS spectra of the cathode surface after cycling at −80° C.

FIG. 31 XPS spectra of the cathode surface after cycling at −80° C.

FIG. 32 A 30 μm×30 μm atomic force microscopy (AFM) topography image of the anode surface after cycling at −80° C.

FIG. 33 Energy-dispersive X-ray spectroscopy (EDS) elemental mapping of the cathode after cycling at 25° C., showing uniform distribution of key elements (C, O, F, S, N), validating CEI homogeneity

FIG. 34 Energy-dispersive X-ray spectroscopy (EDS) elemental mapping of the cathode after cycling at −80° C., showing uniform distribution of key elements (C, O, F, S, N), validating CEI homogeneity

### DESCRIPTION OF THE INVENTION

The novelty of our work lies not only in the electrolyte formulation, but in the establishment of a generalizable design principle: solvation-shell matching across chemically distinct solvent classes to achieve fast transport and interfacial robustness under extreme thermal conditions. Through an extensive suite of experimental and computational investigations—including Raman spectroscopy, NMR, and temperature-dependent electrochemical measurements—we demonstrate that this BN-DOL electrolyte forms a solvent-separated-ion-pair (SSIP)-dominated solvation structure with an ultralow desolvation activation energy (˜3.35 kJ mol⁻¹), ensuring exceptional ionic mobility at temperatures as low as −80° C. Simultaneously, the interphases formed from TMSP, FEC, DOL ring-opening and BN reduction yield a unique hybrid SEI/CEI rich in polyethers, LiF, and Li₃N—an architecture shown to be mechanically elastic, chemically stable, and highly conductive. We validate the performance of this system in full graphite∥NMC pouch cells, which exhibit unprecedented stable cycling at −80° C., minimal impedance growth, and excellent rate capability across a 130° C. window. A 50 mAh pouch cell fabricated with our electrolyte operated continuously at −80° C. for one month, marking the first real-world demonstration of cryogenic LIB function without external heating. Collectively, this work delivers not only a high-performing electrolyte for ultra-low-temperature applications, but also a transferable framework for electrolyte design rooted in solvation energetics, interfacial chemistry, and coordinated solvent function. These insights redefine the design rules for cryo-electrochemical systems and open the door to the next generation of lithium-ion batteries capable of enduring the harshest environments—ranging from lunar night missions to polar sensing networks and high-altitude aerospace technologies.

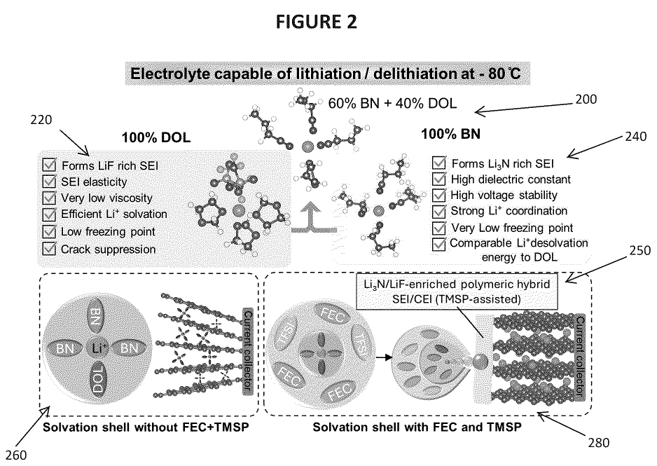

Referring now to FIG. 2, the Top panel, 200 is a schematic illustration of engineering dual solvent systems comprising BN and DOL. When mixed at 60-40 ratio, the unique properties of individual solvent combine to form a special electrolyte system capable of lithiation and delithiation at −80° C. The Bottom panel, 250 is a schematic diagram illustrating co-intercalation of graphite anode without the presence of FEC as additive, which causes exfoliation. However, FEC additive facilitates preventing co-intercalation and ensures anode preservation during lithiation process.

### Materials

All solvents, including 1,3-dioxolane (DOL), butyronitrile (BN), tetrahydrofuran (THF), Fluoroethylene carbonate (FEC), and different lithium salts with ≥99% purity were purchased from Sigma Aldrich. Prior to use, all solvents were thoroughly dried using molecular sieves to ensure minimal water content and preserve electrolyte integrity.

### Electrolyte and Electrodes Preparation

Electrolyte preparation was carried out entirely inside an argon-filled glove box (O₂<0.1 ppm, H₂O<0.01 ppm) to prevent contamination. DOL, BN, LiTFSI, and the additives—FEC and TMSP—were combined in a glass vial and stirred until fully mixed. The cathode consisted of 80 wt % Li(Ni_{0.33}Mn_{0.33}Co_{0.33})O₂ (NMC111), 10 wt % polyvinylidene fluoride (PVDF) binder, and 10 w t% conductive carbon black, cast onto aluminum foil with an active material loading of 4-10 mg/cm². The graphite anode was prepared using 80 wt % high-performance artificial graphite (MSE PRO), 10 wt % PVDF, and 10 wt % conductive carbon black, coated on copper foil with a mass loading of 3-7 mg/cm². An N/P ratio between 1.2 and 2 was maintained for all cells. Prior to assembly, all electrodes were dried under vacuum at 120° C. overnight. A single 20 μm thick, porous polypropylene separator (20 mm diameter) was placed between the 18 mm diameter cathode and anode to ensure proper alignment and effective separation.

### Electrochemical Measurements

Electrochemical evaluations were conducted using 2032-type coin cells, assembled under an inert argon atmosphere inside a glovebox. Each cell featured a graphite anode and an LiNMC-based cathode, tested with various electrolyte systems. Ionic conductivity was determined using a custom-designed conductivity cell composed entirely of SS316L stainless steel electrodes, which were mechanically polished to ensure surface consistency. Calibration of the cell constant was performed using certified standard solutions. Galvanostatic charge-discharge (GCD) experiments were run using a MACCOR 4300 battery testing system across a voltage window of 2.5-4.2 V, with current rates ranging from 0.025 C to 10 C. Electrochemical impedance spectroscopy (EIS) was conducted on a CHI 660E electrochemical workstation across a broad frequency spectrum (0.01 Hz to 1 MHz) using a 5 mV AC perturbation. The impedance data were analyzed using equivalent circuit models on a CHI 660E to extract key parameters. To evaluate rate performance and thermal stability, cells were equilibrated in a temperature-controlled chamber for several hours at the desired test temperatures, followed by cycling under various current densities. These tests covered a wide thermal range, spanning from +70° C. to −80° C. Linear sweep voltammetry (LSV) was also performed on the CHI 660E system using a scan rate of 0.2 mV/s, within a voltage window of 1.0 to 6.0 V.

### Materials Characterization

The structural and surface characteristics of both pristine and cycled graphite electrodes were analyzed using Helios Nanolab scanning electron microscope (SEM) combined with energy-dispersive X-ray spectroscopy (EDS). To investigate the composition of the SEI formed in different electrolyte systems, a ThermoFisher Nexsa G2 X-ray photoelectron spectrometer (XPS) equipped with Al source and a MAGCIS sputtering gun was used. X-ray diffraction (XRD) patterns were collected using a Rigaku MiniFlex 600 system. Copper and Aluminum peaks originating from the current collectors were used for internal calibration during analysis of cycled samples. Atomic force microscopy (AFM-Bruker) was employed to examine surface topography and crack development on electrodes following SEI and CEI formation. Raman spectra of the electrolytes were recorded using a 532 nm laser, with each measurement averaged over 10 exposure cycles to enhance signal quality.

The critical scientific challenge lies in designing an electrolyte with solvation shell that is weak enough to let Li⁺ desolvate quickly at the electrode, yet robust enough to prevent the electrolyte from freezing and maintain electrochemical integrity at extreme temperatures, like −80° C. This study establishes solvation tuning as a robust electrolyte design technique by coupling a high-dielectric, strong-donor nitrile with a low-viscosity, polymerizable ether in an approximately 3:2 ratio yields a weakly-solvated but mechanically and electrochemically resilient shell. This insight provides a concrete pathway for building next-generation electrolytes that enable safe, high-rate lithium-ion operation at −80° C., an operating regime previously unreachable with single-solvent or carbonate systems. To confirm the hypothesis, a series of experimental and computational analysis were performed.

FIG. 2 depicts the mixed solvation shell that forms when BN and DOL are combined as a dual solvent. As shown in box 220, BN has an exceptionally low freezing point (˜−112° C.) and a relatively high static dielectric constant (ε≈25). Those attributes promote complete dissociation of LiTFSI even at −80° C., while the strong dipole of the —C≡N group coordinates tightly with Li⁺. When BN is reductively decomposed on graphite, Box 240, the nitrile fragment yields an inorganic, Li₃N-rich interphase that (i) suppresses dendrite nucleation, (ii) improves the ionic conductivity of the SEI and CEI layers, and (iii) extends the anodic stability window beyond 5 V vs Li/Li⁺. DOL is a low-viscosity ether (η≈0.6 cP at 25° C.) with a freezing point of −95° C., so it preserves fluidity and lowers the bulk viscosity of the electrolyte at deep-cold temperatures. During SEI and CEI formation, five-membered ring of DOL undergoes anionic ring-opening polymerization, producing a flexible polyethylene-oxide (PEI)-like network that is incorporated directly into the interphase. Box 260 shows the solvation shell without FEC+TMSP. Referring now to Box 280, Polymer-integrated SEI and CEI grant mechanical elasticity to the interphases, forming a crack arresting network that effectively suppresses fracture propagation during repeated low-temperature lithiation/delithiation cycles.

In order to collectively occupy the primary shell of Li⁺, the desolvation energies of the solvents must be closely matched, otherwise, the cation will bind almost exclusively to the lower-energy donor, eliminating any cooperative benefit. Because BN and DOL satisfy this criterion, Li⁺ experiences a moderate overall binding energy—sufficient to keep the salt dissociated, yet weak enough to permit rapid desolvation at the electrode. In this mixed shell, BN provides high dielectric screening and exceptional oxidative stability, while DOL lowers viscosity and, through its ether oxygens, softens the Li—N interaction. The result is a solvation environment dominated by SSIPs, which reduces Li⁺-anion drag and limits the activation energy for ionic transport to only ˜3-4 kJ mol⁻¹. Simultaneously, the solid-electrolyte interphase inherits both BN-derived Li₃N domains and flexible polyether species from DOL, combining mechanical resilience with high Li⁺ permeability. Together, these complementary effects—along with the thin nature of the interphase and its resistance to further thickening—enable reversible lithiation and delithiation at −80° C. while supporting voltages above 5 V, thereby addressing the longstanding challenge of coupling cryogenic ion transport with interfacial stability in a single electrolyte formulation.

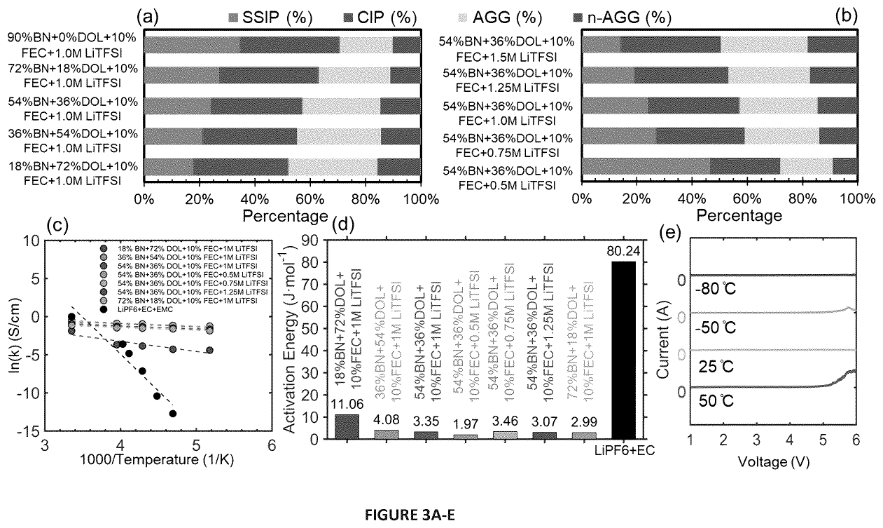

Referring now to FIG. 3, Decomposition of Li⁺ solvation environments into SSIP, CIP, AGG, and non-aggregated species (n-AGG) for (a) (Box 310) different BN-DOL ratio and (b) (Box 320) different salt concentrations, obtained from RAMAN results. (c) (Box 330) Arrhenius plot of ionic conductivity across a temperature range (50° C. to −80° C.) for different electrolyte composition. While BN+DOL dual solvent electrolytes at different compositions show the lowest temperature dependence, a commercial electrolyte (EC+EMC+LiPF6) exhibits strong temperature-dependent transport behavior. (d) (Box 340) Activation energies (Ea) derived from the slopes Arrhenius plots, demonstrating the influence of salt and co-solvent ratios on ion mobility. The BN:DOL (54:36)+10% FEC+1.0 M LiTFSI formulation exhibits the lowest activation energy of 1.97 kJ/mol. (e) (Box 350) Linear sweep voltammetry (LSV) profiles at −80° C., −50° C., 25° C., and 50° C., which show a wide electrochemical stability window across different temperatures.

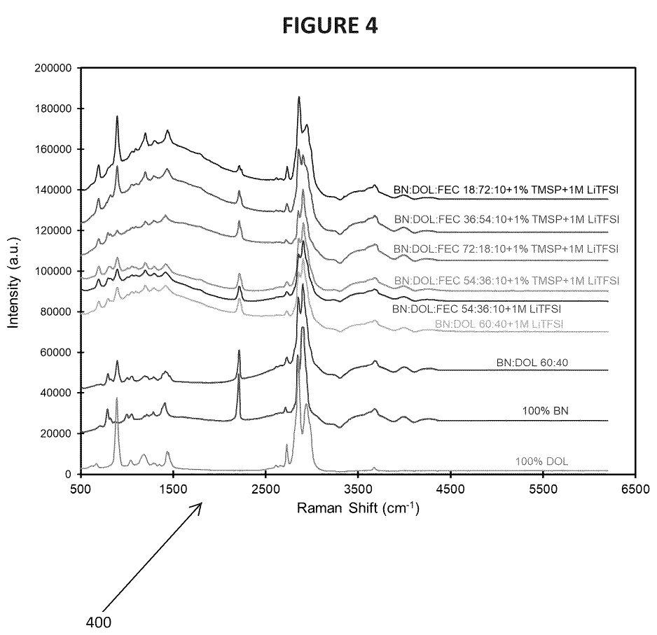

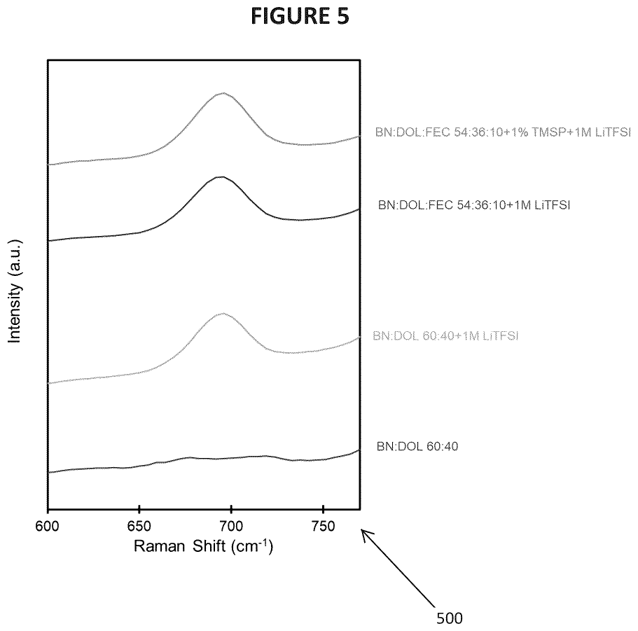

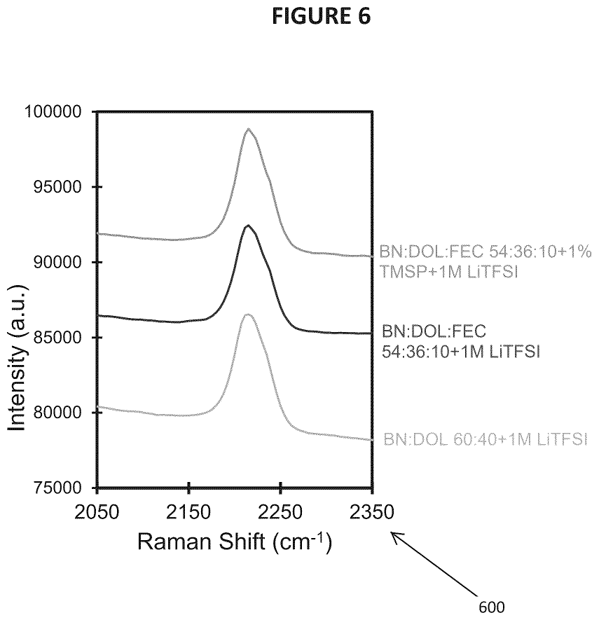

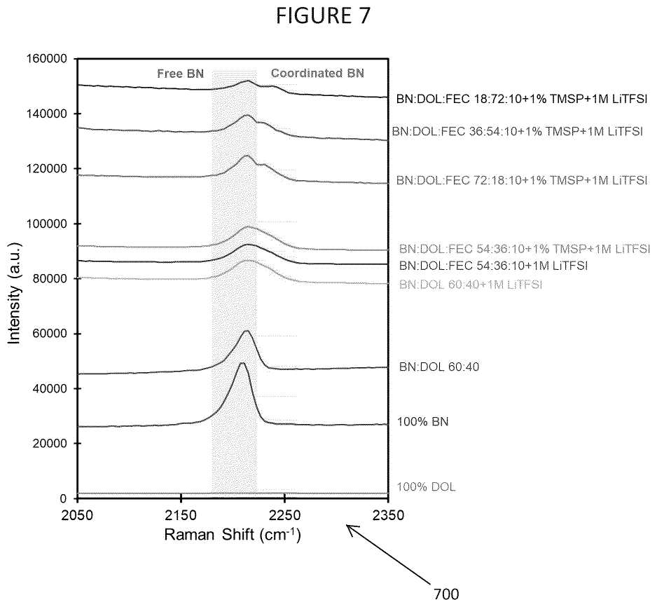

To test this hypothesis, we probed solvation-shell changes with Raman spectroscopy (FIG. 3a-b and FIGS. 4-7, Chart 400, 500, 600, and 700 respectively). FIG. 3a shows how the ion-pair distribution evolves as the BN DOL ratio is varied at a fixed 1 M LiTFSI concentration with 10% FEC and 1% TMSP.

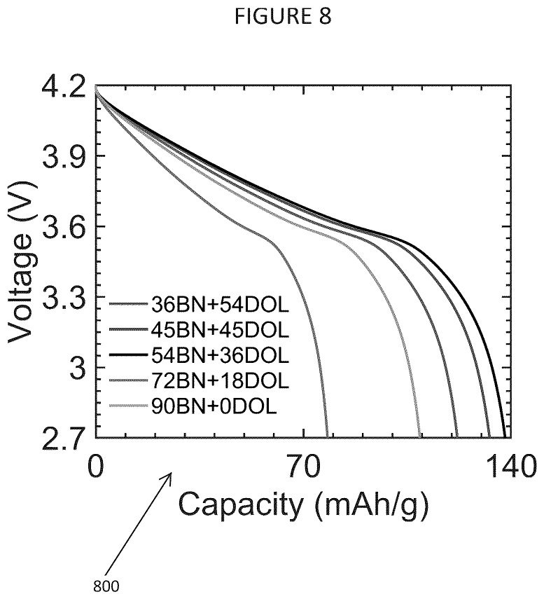

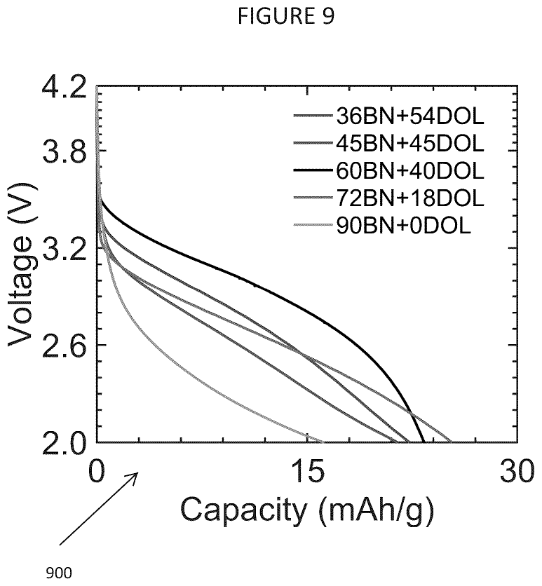

In FIGS. 8-11 (Charts 800, 900, 1000, and 1100 respectively), it is systematically optimized the electrolyte formulation by varying the percentage of FEC, the concentration of TMSP, and the type of ether solvent, identifying DOL as the most effective ether for stable performance across 25° C. and −80° C. In the DOL-rich electrolyte, the SSIP content is very low (≈18%), while contact ion pairs (CIP) (≈35%) and aggregates (AGG) species (>30%) dominate. The low dielectric constant of DOL and its limited ability to stabilize Li⁺ solvation favors strong Li⁺-TFSI⁻ association. As BN content increases, nitrile groups with stronger donor ability compete with ether oxygens for Li⁺ coordination, while the higher polarity of BN enhances dielectric screening. This gradually displaces TFSI⁻ from the first solvation shell, reducing aggregate formation and raising the SSIP fraction. At 54% BN, the system reaches a balanced state: SSIPs increase to ≈24% while aggregates drop below 30%. This composition provides moderate binding strength and improved ionic dissociation, yielding a relatively loose solvation cage favorable for Li⁺ transport at low temperatures. At higher BN content (72-90%), the SSIP fraction continues to rise (up to ≈35%), and aggregate populations fall to below 20%. The stronger —C≡N···Li⁺ coordination in BN helps suppress ion clustering, but excessive BN also increases viscosity and reduces dynamic mobility. BN molecules interact strongly through dipole-dipole attractions among their nitrile groups and through enhanced Li⁺-solvent coordination lifetimes. These interactions slow down molecular reorganization and ion mobility, reducing overall ionic conductivity. Thus, although SSIP fractions are highest in BN-rich formulations, the trade-off between dissociation and mobility suggests that intermediate BN:DOL ratios offer the most efficient environment for cryogenic Li⁺ transport.

Raman spectroscopy (FIG. 4-7) collected for BN:DOL (54:36) blends without additives, with only FEC, and with both FEC and TMSP shows nearly identical LiTFSI-related band positions and peak shapes. This indicates that the primary Li⁺ coordination environment with BN, DOL, and TFSI⁻ remains unchanged in the presence of FEC and TMSP. Both additives, while polar, are weak Lewis donors and are introduced only in small fractions, preventing them from competing with BN or DOL donors or displacing TFSI⁻ from the first solvation shell. Consistently, the characteristic TFSI⁻ peaks, as well as the BN- and DOL-associated coordination bands, show no changes in the relative intensities of ion pairs versus free solvent, confirming that the ion-pairing and coordination ratios remain unaffected. Instead, FEC and TMSP reside primarily in the secondary solvation sphere, functioning as electrochemical additives rather than primary ligands.

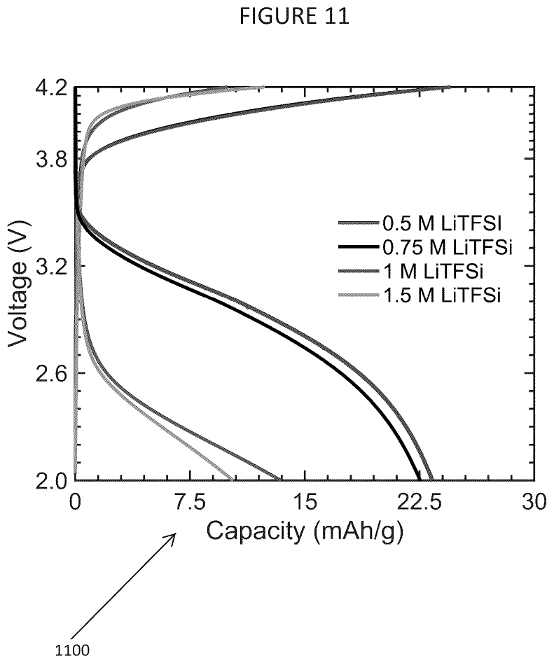

FIG. 3b tracks how the LiTFSI concentration shapes the local ion-pair landscape in the fixed solvent. At the lowest loading, 0.5 M, nearly all Li⁺ resides in SSIPs, confirming that TFSI⁻ is effectively screened and kept out of the primary shell, a configuration that maximizes individual ion mobility (FIG. 3c). The drawback is that during real cycling, the small Li⁺ inventory near the electrodes is quickly depleted, concentration gradients build up, and voltage sag or lithium plating begins (FIG. 11). Because there are few TFSI⁻ fragments, the SEI layer that forms are mostly soft poly-DOL and do not protect the surface well at low temperatures (FIG. 11). Raising the salt content to 0.75 M and 1.0 M increases carrier density while only insignificantly reducing the SSIP fraction. These two concentrations therefore strike a practical compromise: enough Li⁺ to carry current, yet not so much anion crowding that mobility plunges and increasing viscosity. Across the mid-range, 0.75 M and 1.0 M LiTFSI deliver very similar bulk conductivities, reflecting their nearly identical SSIP content. Beyond this optimal concentration range, at 1.25 M and 1.5 M LiTFSI, the SSIP population collapses while CIPs and larger AGGs proliferate, signaling that TFSI⁻ has re-entered Li⁺'s first shell. These bulky Li⁺-TFSI⁻ complexes create steric congestion, assemble into dense ionic clusters, and drive the bulk viscosity sharply upward. The combination of thicker solvation cages and a more sluggish solvent matrix severely hampers Li⁺ mobility—penalties that become even more acute at cryogenic temperatures, where any added viscous drag further suppresses conductivity.

FIG. 3c extends the solvation analysis to transport kinetics by plotting the Arrhenius behavior for every formulation. The reference carbonate electrolyte (1M LiPF₆/EC+EMC) shows the steepest slope, reflecting an activation energy (Eₐ) of 80.24 kJ/mol (FIG. 3 d). By contrast, every BN-DOL blend traces a much flatter trajectory, signaling markedly weaker temperature dependence. The improvement scales with the SSIP content extracted in Raman results: electrolytes whose solvation shells are dominated by SSIPs cluster near the top of the conductivity envelope and yield low Eₐ values. Although increasing BN content enhances SSIP formation, the ionic conductivity decreases slightly at 72% BN because of possible over-stabilization of Li⁺ solvation environments, which limit long-range ion transport. The formulation that best balances ion inventory and mobility—54% BN/36% DOL/10% FEC with 1.0 M LiTFSI—exhibits an activation energy of just 3.35 kJ mol⁻¹, more than an order of magnitude lower than the conventional electrolyte. An even lower Eₐ (1.97 kJ mol⁻¹) is obtained at 0.5 M LiTFSI, but its poor long-term electrochemical properties are the main issue (FIG. 11).

FIG. 3 e shows linear-sweep voltammograms of the 1 MLiTFSI/54 % BN-36% DOL+FEC electrolyte from −80° C. to 50° C. In every trace the current stays at baseline until ≈5 V, indicating a stable oxidative window in a broad range of temperature; only minor leakage appears at the highest temperature, while the −80° C. curve is essentially flat. This confirms that the mixed BN-DOL shell resists solvent or salt oxidation and remains electrochemically inert from deep-cold to moderately high temperatures.

DOL contributes ultra-low viscosity and ring-opening film formation, while BN provides high dielectric screening, Li₃N-rich interphase species, and oxidative stability beyond 5 V. The resulting balanced ΔG_{desolvation} underlies the experimentally low activation energy (FIG. 3d).

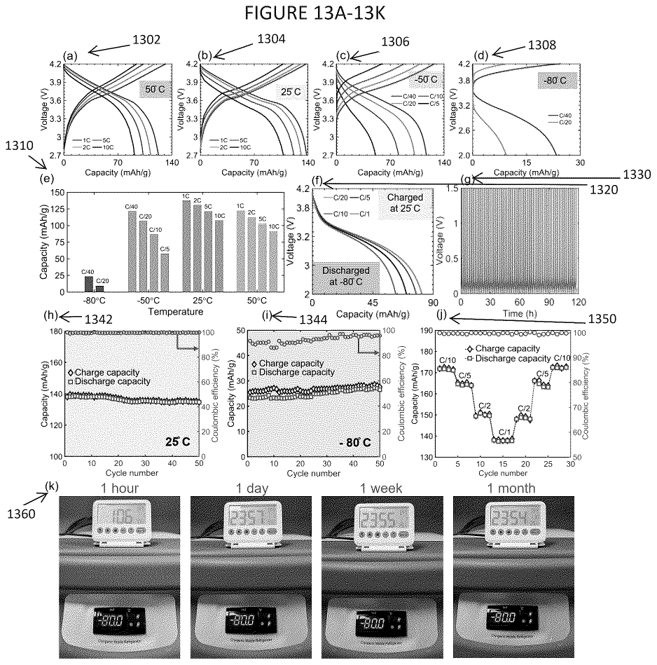

Referring now to FIG. 13. Galvanostatic charge/discharge (GCD) profiles for full cells with our electrolyte comprised of BN:DOL (54:36)+10% FEC+1.0 M LiTFSI electrolyte at (a, Box 1302) 50° C., (b, Box 1304) 25° C., (c, Box 1306) −50° C., and (d, Box 1308) −80° C. operating at different current rates. (e, Box 1310) Summary of discharge capacities extracted from GCD data at each temperature and C-rate. (f, Box 1320) Discharge profiles of cells with our electrolyte, pre-charged at 25° C. and subsequently discharged at −80° C. under different C-rates. (g, Box 1330) Long term stability test of a half-cell (Li∥graphite) with our electrolyte at 25° C., confirming compatibility with the graphite anode. Cycling performance and respective coulombic efficiency of our electrolyte at (h, Box 1342) 25° C. and (l, Box 1344) −80° C. for 50 cycles, showing minimal capacity degradation even at ultra-low temperature. (j, Box 1350) Rate capability test of our electrolyte performed at 25° C., showing the reversible capacity response to progressively increasing C-rates (C/10 to 1 C and back), validating the ability to recover the battery performance after fast cycling rate. (k, Box 1360) Practical demonstration of a functional pouch cell operating inside a cryogenic freezer continuously at −80° C. for 1 month, powering a digital clock, further emphasizing the practicality and robustness of our electrolyte system.

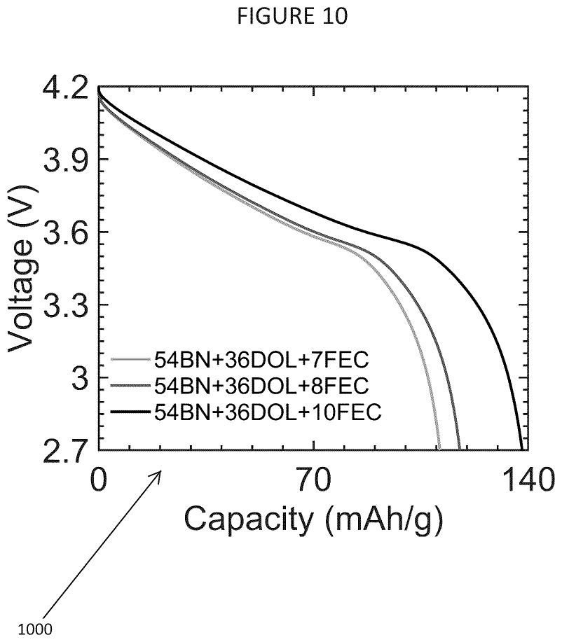

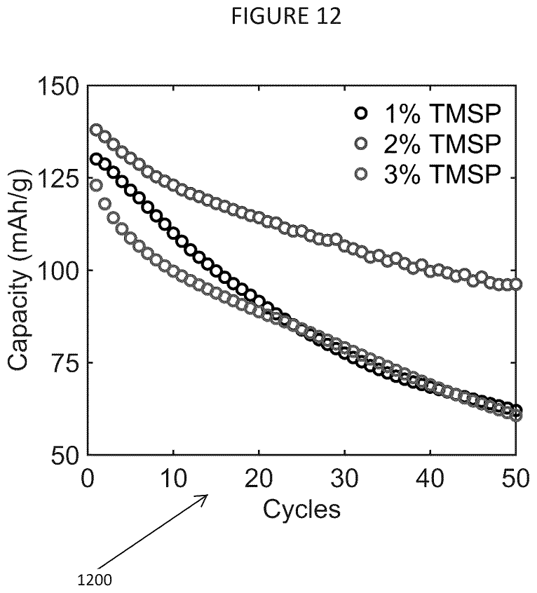

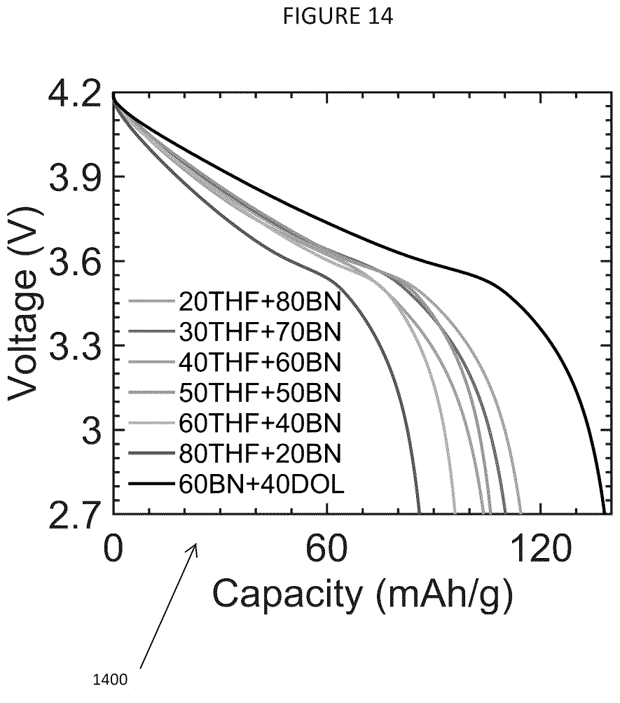

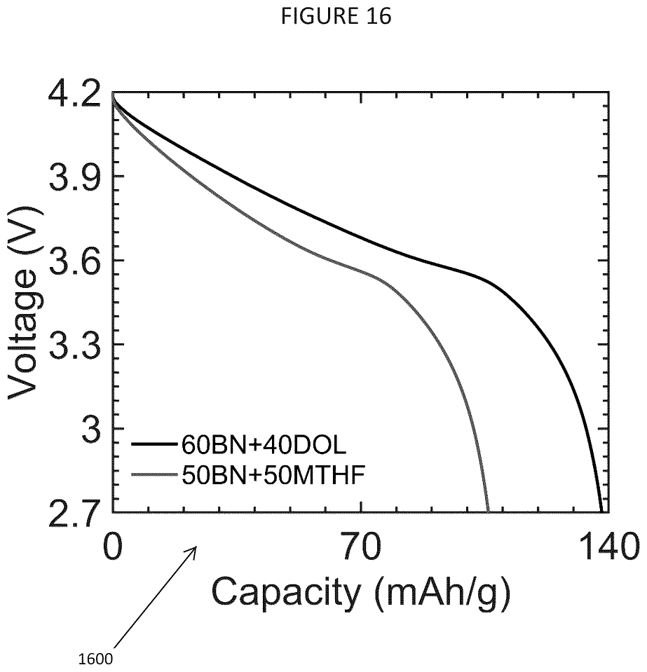

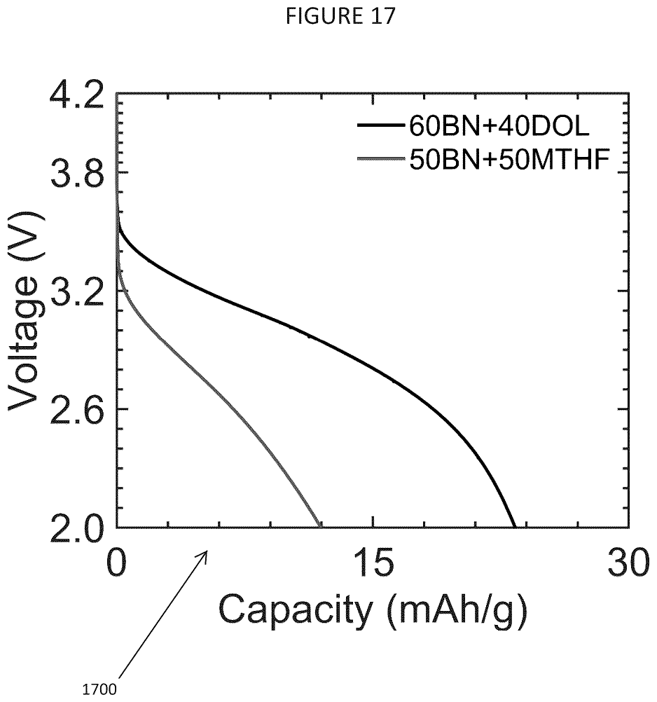

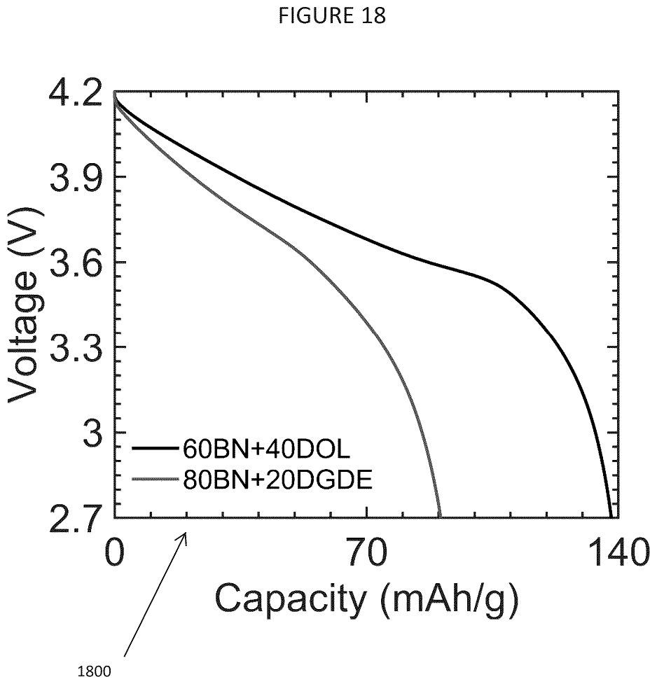

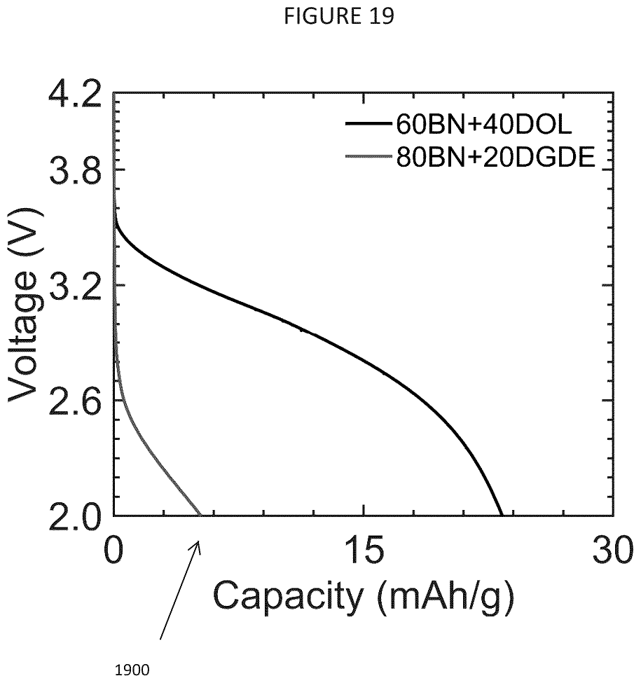

After optimizing the BN:DOL solvent ratio, we systematically tuned the remaining electrolyte components. Salt type was calibrated first (FIG. 14-19, Charts 1400, 1500, 1600, 1700, 1800, and 1900 respectively), followed by the FEC solvent % (FIG. 10) and the TMSP additive (FIG. 12, Chart 1200). Galvanostatic cycling data for different types of salts (FIG. 11) showed that 1M LiTFSI delivers the highest capacity retention and the best graphite compatibility. Additive screening (FIGS. 10 & 12) indicated that a combination of 10 vol % FEC and 2 wt % TMSP outperforms alternatives such as VC or EC, providing the most robust SEI and longest cycle life. We did not pursue Li-metal anodes since metallic lithium becomes too rigid to strip uniformly at temperature below −40° C. So, the Li foil surface hardens, its exchange current density plummets, and the SEI resistance soars. Under these conditions Li⁺ cannot be pulled out of the foil fast enough, large overpotentials develop, and the cell reaches its voltage limits before any meaningful charge is transferred.

Our novel dual-solvent electrolyte demonstrated outstanding electrochemical properties, enabling excellent full-cell performance across a wide temperature range from +50° C. to −80° C., as shown in FIG. 3. At 50° C. (FIG. 3a), the cells exhibit high discharge capacities with stable voltage profiles across all current rates. At room temperature, a regime where conventional nitrile-based electrolytes often suffer from reductive decomposition at the graphite surface²⁴, our BN-DOL electrolyte delivered impressive capacities of 138 mA/g at 1 C, 131 mAh/g at 2 C, 121 mAh/g at 5 C, and 108 mAh/g at 10 C (FIG. 3b). These results highlight the exceptional reduction stability and fast-charging capability of the electrolyte, a significant advancement over earlier nitrile systems. When cycled at −50° C. (FIG. 3c), the cell achieved nearly complete lithiation and delithiation, delivering capacities closely matching those at room temperature—an uncommon result at such subzero conditions where interfacial kinetics and ionic mobility are typically severely limited. Even more remarkably, full lithiation was successfully initiated at −80° C. (FIG. 3d), as evidenced by clear voltage plateaus and measurable discharge capacities of ˜23 mAh g⁻¹ at C/40 and ˜13 mAh g⁻¹ at C/20. To the best of our knowledge, this is the first demonstration of a lithium-ion battery completing both charge and discharge cycles entirely at −80° C., marking a major advancement in cryogenic electrochemistry. This achievement confirms that our BN-DOL electrolyte enables not only ionic conduction but also effective lithium intercalation into graphite and deintercalation from the cathode at ultra-low temperatures—capabilities that have not been reported for any previous electrolyte system. The successful lithiation/delithiation at −80° C. is primarily enabled by the weakly solvated, mixed-donor (Li—O and Li—N) coordination environment formed by BN and DOL, as supported by Raman results. This solvation structure facilitates rapid desolvation and stable ion transport even under cryogenic conditions, resulting in a low activation energy and the ability to sustain full intercalation reactions at ultra-low temperatures. FIG. 3e summarizes the electrolyte's stable high-rate performance from +50° C. to −50° C., with minimal capacity fading. Notably, it also enables full charge-discharge at −80° C., distinguishing it from all previously reported systems.

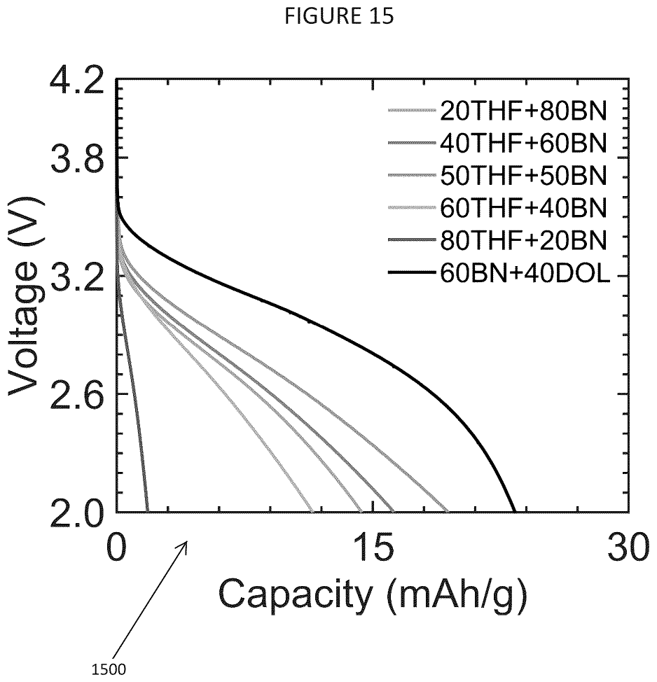

To benchmark our performance against previous studies, we evaluated the commonly used protocol of charging at room temperature and discharging at −80° C. (FIG. 3f), further validating the superior low-temperature compatibility of our electrolyte system. As shown in FIG. 3f, the battery delivers excellent discharge capacities under these conditions, achieving ˜88 mAh/g at C/20 and ˜77 mAh/g at C/10—far exceeding the performance reported under comparable conditions (FIG. 15j). Even at higher current rates of C/5 and C/1, the same battery maintained the discharge capacities of ˜70 mAh/g and ˜62 mAh/g, respectively. To assess the compatibility of our electrolyte with graphite anode, a half-cell was cycled at room temperature for over 100 hours, as shown in FIG. 3g. The cell shows highly reversible and stable voltage profiles over the cycling period. The graphite redox plateau is maintained throughout the charge discharge process, which suggests the formation of stable SEI layer.

Now, the cycling performance of our batteries at 25° C. and −80° C. (FIG. 3h, i) provides essential validation of durability of our electrolyte system under both ambient and ultra-low temperatures. At 25° C., the battery shows insignificant capacity reduction after 50 cycles at 1 C, an extremely high fast rate. Notably, the coulombic efficiency remains close to 100% throughout cycling, indicating stable SEI and CEI formation with minimal side reactions. One of the most groundbreaking outcomes of this study is the unprecedented demonstration of stable long-term cycling of a lithium-ion battery at −80° C. Over 50 continuous cycles at −80° C., the battery consistently delivered ˜23 mAh/g of discharge capacity without any observable capacity fade for over 300 h. Remarkably, the coulombic efficiency remained high—approaching 90%—and improved steadily throughout the cycling process. These findings confirm that our dual-solvent electrolyte not only enables efficient Li⁺ desolvation and intercalation at cryogenic conditions but also supports the formation of durable SEI/CEI layers over extended operation. Such performance remains largely unattainable with conventional electrolyte systems.

In order to analyze the rate capability of our electrolyte, a full cell was tested at progressively increasing current rates from 0.1 C to 1 C, followed by recovery to 0.1 C (FIG. 3 j). At 0.1 C, the cell maintained a capacity of ˜170 mAh/g and upon returning to 0.1 C after being cycled aggressively at 1 C, the discharge capacity was almost fully restored. This result suggests minimal irreversible capacity loss while cycling at high rates. Additionally, the consistently almost perfect coulombic efficiency of ˜99.9% across all current densities confirms that the electrolyte maintains a stable electrochemical environment and suppresses any parasitic reactions.

To demonstrate real-world applicability, we fabricated a 50 mAh pouch cell, charged it at −50° C., and discharged it at −80° C. by powering a 3 V digital timer. As shown in FIG. 3k, the cell operated (discharged) continuously for one month under these extreme cryogenic conditions without interruption. This sustained operation represents a significant milestone in enabling practical lithium-ion battery performance at ultra-low temperatures.

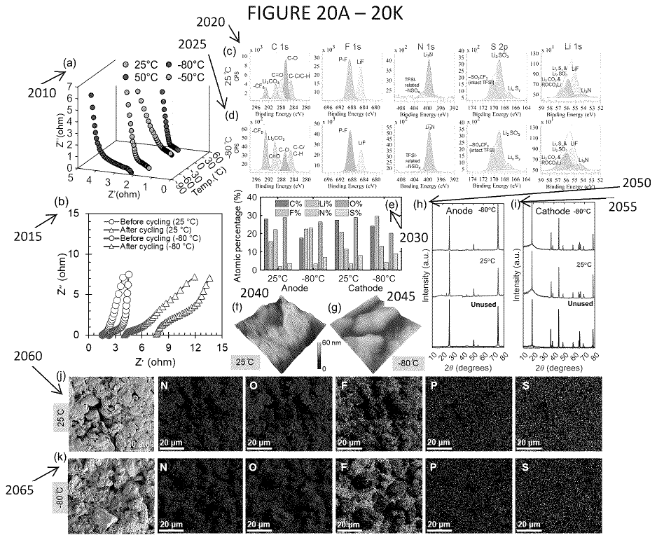

To understand the intrinsic mechanism behind this exceptional performance of our dual solvent electrolyte, we performed thorough post cycling characterization on our electrodes. FIG. 20a (Box 2010) shows Nyquist plots of graphite∥LINMC cells using the BN-DOL electrolyte (1M LiTFSI in 54% BN-36% DOL-10% FEC) measured from +50° C. to −80° C. As temperature decreases, the semicircle diameter increases, reflecting rising interfacial resistance due to slower Li⁺ transport and desolvation kinetics. Despite this, impedance remains relatively low even at −80° C., confirming the electrolyte's ability to maintain ionic conduction and interfacial stability at cryogenic temperatures. FIG. 20 b (Box 2020) compares impedance before and after 50 cycles at 25° C. and −80° C. At both temperatures, the Nyquist spectra reveal a noticeable increase in bulk electrolyte resistance, which is likely attributed to gradual electrolyte decomposition and partial loss of ionic conductivity during cycling, particularly under cryogenic conditions where viscosity and ion mobility are inherently lower. In contrast, only modest changes in the charge-transfer semicircle are observed after subjecting to the lithiation/delithiation cycling, indicating the formation of ultrathin SEI/CEI layers that remain stable and conductive. The preserved interfacial response, even at −80° C., underscores the robustness of the tailored BN-DOL solvation environment for prolonged operation in extreme cold.

Referring now to FIG. 20. (a, Box 2010) EIS results of cells with BN:DOL (54:36)+10% FEC+1.0 M LiTFSI electrolyte at 50° C., 25° C., −50° C., and −80° C. showing low bulk resistance. (b, Box 2015) EIS analysis before and after cycling at 25° C. and −80° C., revealing no thick SEI growth and absence of severe passivation. (c-d, Box 2020 and 2025) High resolution XPS spectra of cycled graphite anodes showing decomposition products, C 1s, F 1s, N 1s, S 2p, and Li 1s. (e, Box 2030) Elemental atomic percentages from the XPS analysis of cycled anodes and cathodes at 25° C. and −80° C., showing preserved fluorine and sulfur content across temperatures. AFM height maps of the anode after cycling at (f, Box 2040) 25° C. and (g, Box 2045) −80° C., which show no evidence of graphite exfoliation or surface damage. XRD plots of cycled and pristine (h, Box 2050) anodes, and (I, Box 2055) cathodes, showing no structural degradation or significant SEI/CEI diffraction signals due to their nanoscale thickness. SEM and EDS elemental mapping of anodes after cycling at (j, Box 2060) 25° C. and (k, Box 2065) −80° C., which exhibit uniform deposition of N, O, F, P, and S.

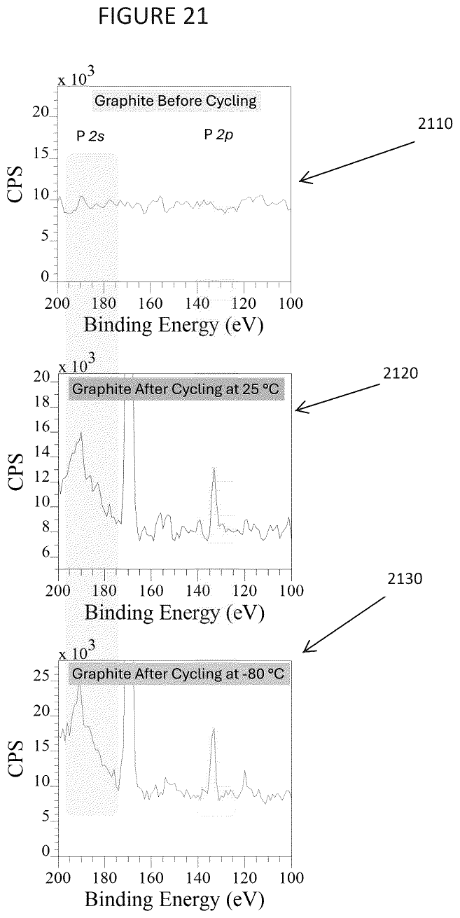

To elucidate the chemical structure and temperature-driven evolution of interfacial layers in our BN-DOL electrolyte system, high-resolution XPS was performed on both anodes (FIG. 20c-e) and cathodes (FIG. S17-S26) cycled at 25° C. and −80° C. Panels 20c and 20d compare core-level spectra of key elements at these two temperatures, while 20e presents the atomic composition extracted from surface analysis. Across both conditions, the C 1s spectra reveal a dominant peak at ˜286.5 eV, consistent with C—O bonding from polyether species formed by DOL ring-opening polymerization. These polymeric chains create a compliant matrix that stabilizes the SEI/CEI and mitigates mechanical cracking, especially critical at −80° C. where electrode volume fluctuations are amplified. The C—C/C—H (˜285 eV) and C═O (˜288 eV) peaks originate from organic backbones and mostly from FEC, which also helps to stabilize a flexible SEI. The strong Li₂CO₃ peak (˜290 eV) confirms the presence of stable inorganic SEI species, which facilitates chemical passivation and prevents electrolyte decomposition. In both F 1s and Li 1s spectra, the strong LiF peaks (˜685 eV and ˜55.3 eV, respectively) confirm extensive formation of LiF from FEC and LiTFSI decomposition. This LiF-rich structure is known to enhance mechanical robustness and electrochemical stability, particularly at low temperatures. The LiF-rich interphase is expected from FEC's early reduction, while TMSP acts as a sacrificial phosphate precursor and HF scavenger to form LixPO_{y}F_{z}-like species (FIG. 21, Charts Boxes 2110, 2120, and 2130), reinforcing the C/SEI network and suppressing further F-containing salt decomposition. The net result is a thin (few-nm), inorganic-rich, ion-permeable SEI that maintains interfacial stability from 50° C. to −80° C., with colder operation favoring the inorganic (LiF/phosphate) fraction over organic carbonates.

Importantly, N 1s spectra at ˜399.5 eV and Li 1s spectra at ˜54 eV both exhibit clear signals attributed to Li₃N, a highly conductive inorganic nitride derived from BN reduction. The Li₃N presence is more pronounced at −80° C. (FIG. 20e), confirming that BN actively contributes to SEI/CEI construction under cryogenic conditions. This aligns with Raman results, which predicted co-coordination of DOL and BN within the solvation shell and subsequent decomposition into functional SEI/CEI components. The increased Li₃N content accounts for the superior interfacial conductivity observed at ultra-low temperatures, consistent with the EIS results in FIG. 20a-b, which exhibit minimal impedance growth after extended cycling at −80° C.

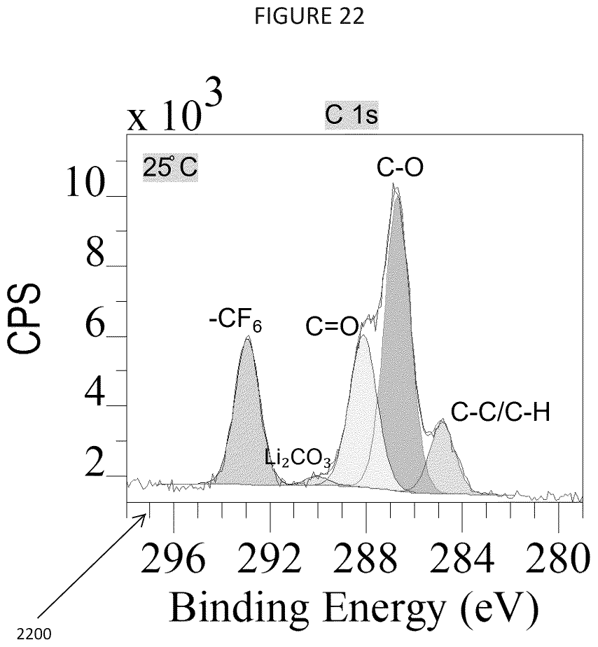

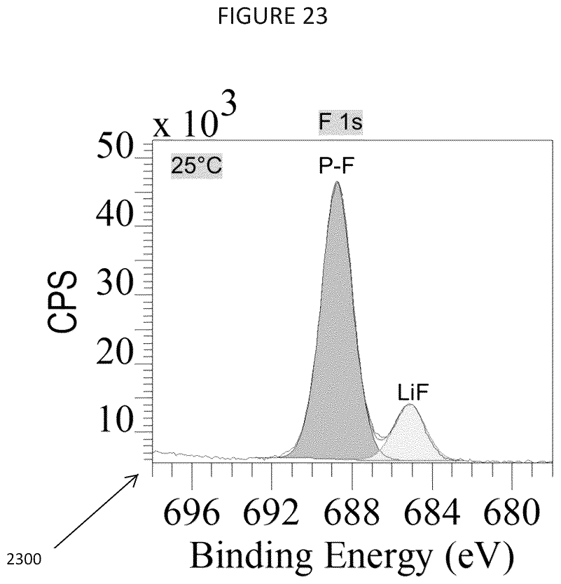

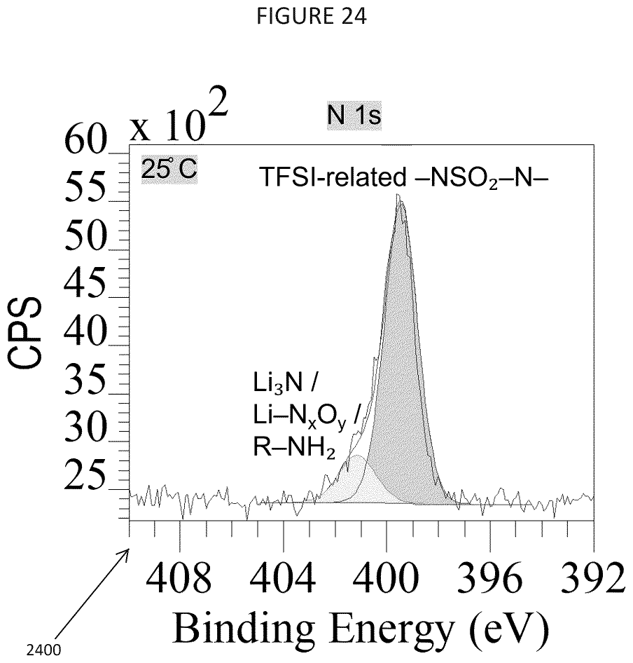

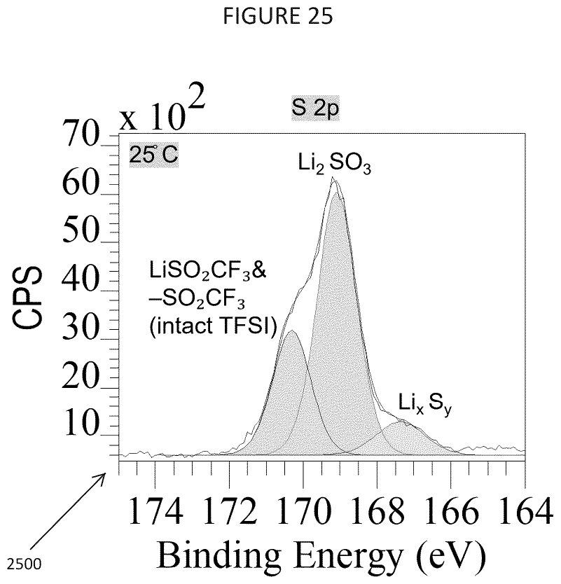

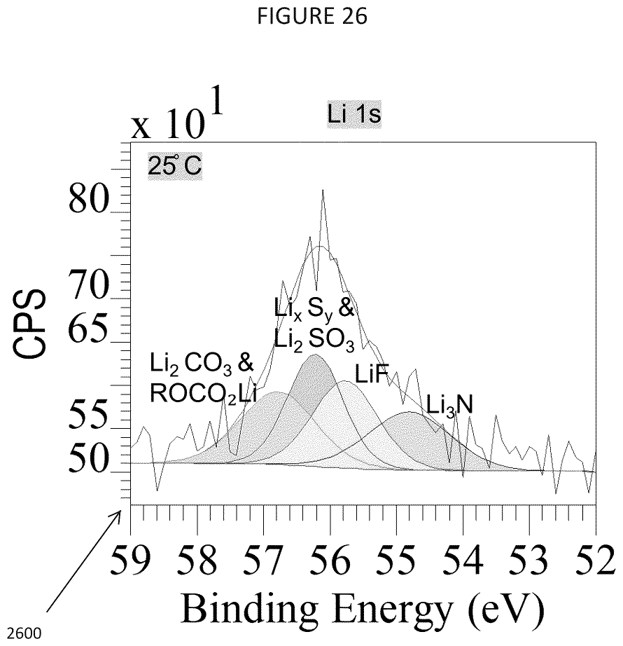

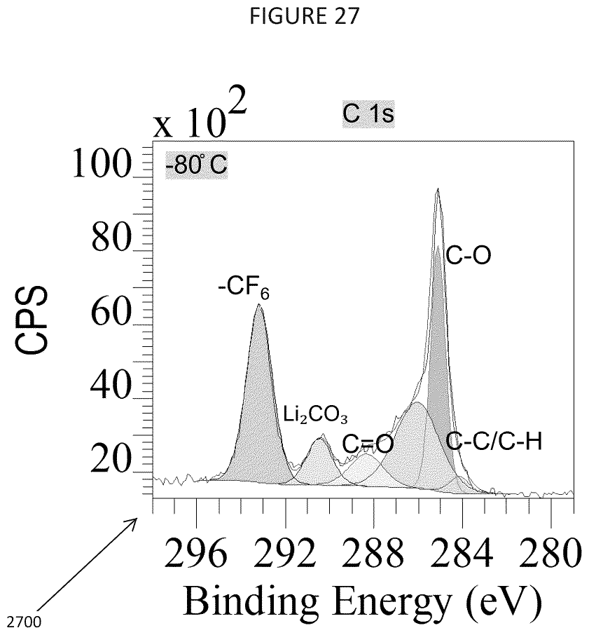

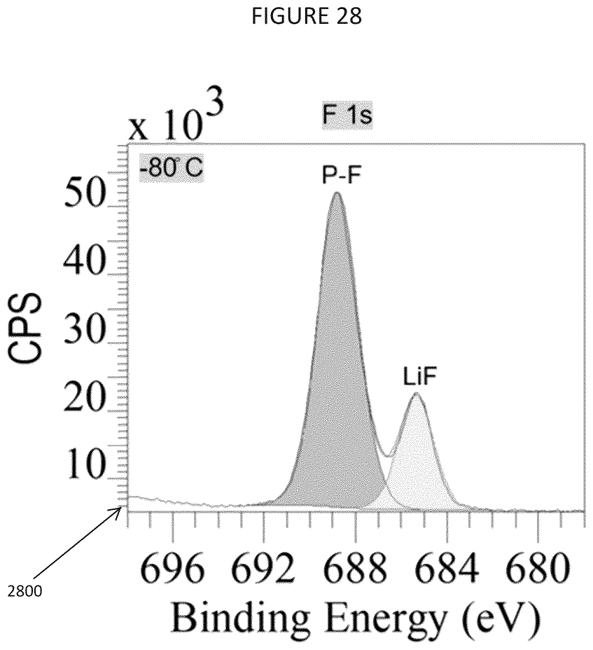

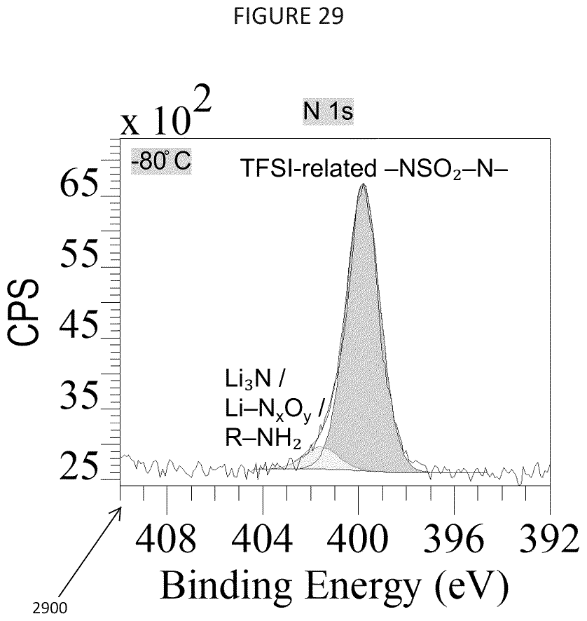

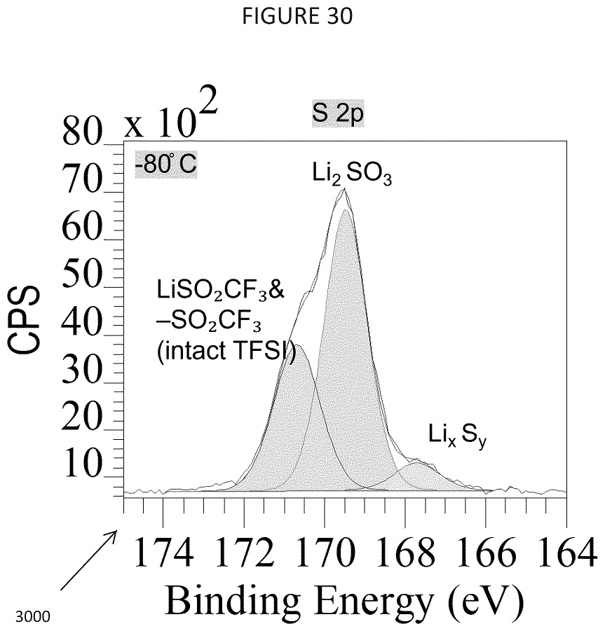

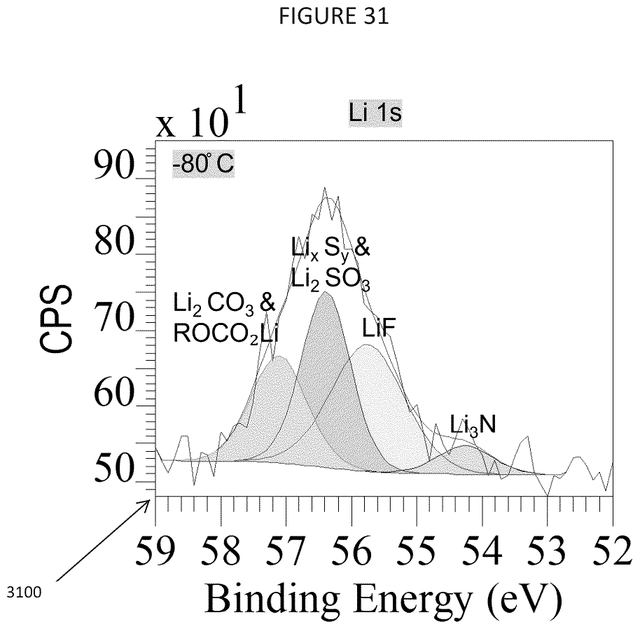

In the S 2p region, peaks from Li₂SO₃, SO₂CF₃⁻, and residual TFSI⁻ species indicate partial reduction of the LiTFSI salt, adding to the inorganic framework. These species are preserved across both temperatures, suggesting that LiTFSI contributes consistently to SEI/CEI formation. Panel 4e quantifies these trends. At −80° C., the anode exhibits elevated F and N contents, signifying a high percentage of LiF and Li₃N components in the SEI and CEI. The rise in N also underscores the decomposition of BN at low temperature—a central element in our electrolyte design to provide excellent ion transfer and conductivity at the SEI and CEI. The cathode data (FIGS. 22-31, Charts 2200, 2300, 2400, 2500, 2600, 2700, 2800, 2900, 3000, 3100 respectively) mirrors this trend, with increased F and N contributions at −80° C. pointing to LiF- and Li₃N-rich CEI layers that preserve cathodic stability during cold cycling. Together, these XPS findings provide compelling chemical evidence that supports the mechanistic hypothesis established by Raman and EIS: the co-solvation of BN and DOL enables the formation of a dual-functional SEI/CEI composed of LiF, Li₃N, and polyethers. This hybrid interphase architecture ensures high ionic conductivity, mechanical flexibility, and excellent stability at cryogenic temperatures, validating the electrolyte's unprecedented cycling performance at −80° C.

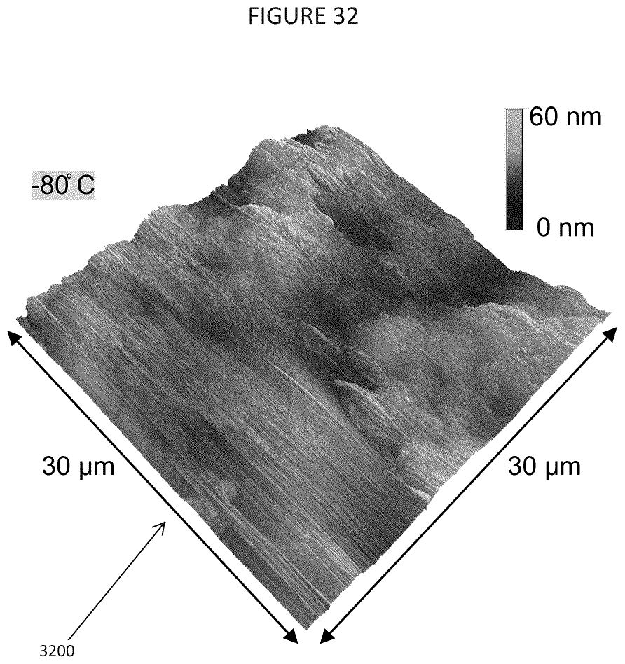

AFM topography (FIG. 20f-g, FIGS. 32, 3200) underscores the interfacial robustness of graphite after cycling at 25° C. and −80° C. In FIG. 20f the layered graphite terraces are clearly visible and uniformly coated; no exfoliation or surface cracks appear, confirming a cohesive SEI. The −80° C. image (FIG. 20g) likewise shows a smooth, crack-free film, obtained in non-contact mode. This uniformity stems from the DOL-derived poly-ether network that imparts elasticity, allowing the SEI to absorb volume changes and self-heal micro-defects during cycling—even under cryogenic stress—thereby safeguarding anode integrity.

To further investigate the structural evolution of the electrodes before and after cycling at 25° C. and −80° C., the X-ray diffraction (XRD) plots are illustrated in FIG. 20h, i. Firstly, unused and the two anodes after cycling exhibit the characteristic graphite (002) reflection (˜26.5 2θ), which confirms that the graphite structure is intact after the long duration cycling at both temperatures. Note that no new peak is observed in any of the post cycling anodes for lithiated graphite, LiC₆ (˜24.0°). This is a clear indication of effective intercalation/deintercalation. The presence of the (110)/(111) doublet of monoclinic Li₂CO₃ (˜23 2θ) indicates that a portion of DOL (and residual CO₂/H₂O) was oxidatively/radically decomposed during cycling, producing carbonate species that precipitated on the graphite surface and became part of the SEI. Importantly, there is no reflection of NMC components. Therefore, it excludes the possibility of cathode disintegration or metal migration to the anode, even under the extreme freezing conditions. Now, from the XRD of cathodes, it is evident that the NMC is well preserved despite being cycled for a long time at 25° C. and −80° C., as there is no change in the sharp, well-defined peaks observed in the unused cathode. Moreover, no peak broadening can be seen either, which suggests the excellent structural stability of the cathode after cycling. The fact that there is no change in NMC reflections after being cycled at an extreme temperature highlights the robustness of the CEI layer and its ability to prevent cathode degradation.

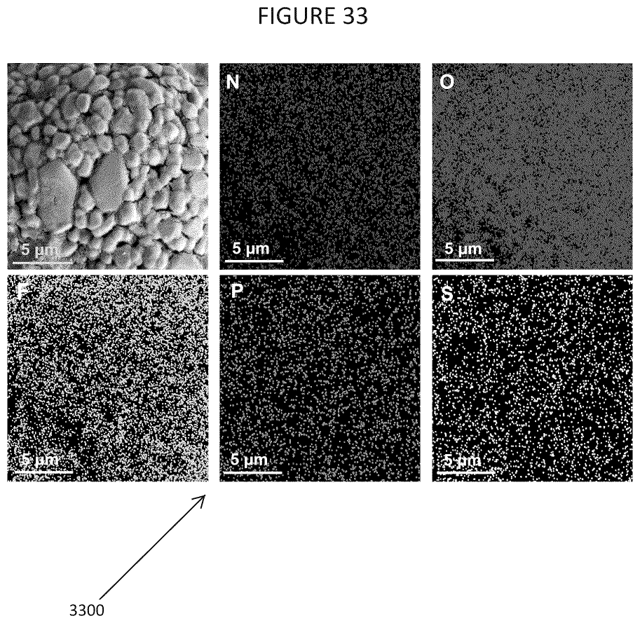

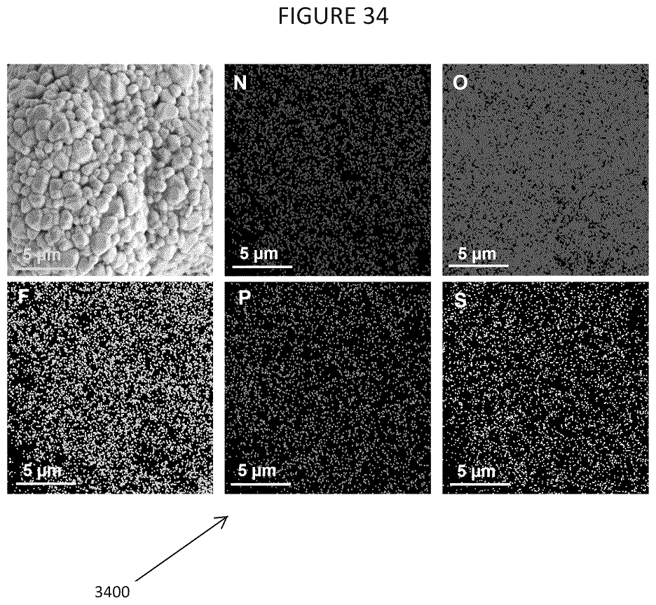

SEM-EDS analysis of the cycled anodes (FIG. 20 j, k, FIG. 33 (Box 3300) and FIG. 34 (Box 3400)) reinforces the interfacial picture drawn from AFM, XRD, and XPS. The SEM micrographs confirm an intact, exfoliation-free graphite surface at both 25° C. and −80° C., highlighting the FEC-assisted, crack-resistant SEI. Elemental maps reveal uniform distributions of N, O, and F—signatures of Li₃N, Li₂CO₃, and LiF that dominate the hybrid SEI. Smaller yet homogeneous P and S signals originate from TMSP and TFSI decomposition, further integrating into the interphase. It is worth noting that the EDS mapping does not show any significant aggregation of transition metal like, Ni, Co, Mn, which proves that there is negligible cathode disintegration on the anode. Collectively, these findings confirm that our novel electrolyte fashions a chemically stable, ion-conductive SEI that preserves graphite integrity and underpins the cell's unprecedented −80° C. performance.

We establish a general, physics-grounded principle for enabling reversible Li-ion operation at −80° C.: co-design the solvation shell and interphase so that (i) donor strengths and desolvation energetics of mixed solvents are closely matched, yielding SSIP-dominated coordination with low activation barriers for Li⁺ transport, and (ii) the resulting interphase is thin, inorganic-rich, and elastically reinforced. Implementing this principle with a BN-DOL dual solvent, complemented by FEC and TMSP, produces a mixed Li—N/Li—O primary shell with ultralow desolvation energy and forms a hybrid SEI/CEI comprising LiF and Li₃N domains embedded in polymeric ethers. Electrochemically, full cells cycle from +50° C. to −80° C. with minimal impedance growth, high coulombic efficiency, and demonstrable functionality at −80° C.

This work was primarily supported by the National Science Foundation through Award No. 2521593, “Solvation Dynamics in Dual-Solvent Systems for Enhanced Electrochemical Performance at Ultra-Low Temperatures” (CBET Division of Chemical, Bioengineering, Environmental, and Transport Systems.

We claim:

1. An electrolyte composition for a lithium-ion battery, comprising:
(a) a first solvent comprising one or more ethers selected from the group consisting of 1,3-dioxolane (DOL), dimethoxyethane (DME), tetrahydrofuran (THF), or combinations thereof;
(b) a second solvent comprising one or more nitriles selected from the group consisting of butyronitrile (BN), acetonitrile (AN), isobutyronitrile (iBN), or combinations thereof;
(c) a lithium salt selected from the group consisting of lithium bis(trifluoromethanesulfonyl)imide (LiTFSI), lithium bis(fluorosulfonyl)imide (LiFSI), lithium hexafluorophosphate (LiPF₆), lithium perchlorate (LiClO₄), lithium tetrafluoroborate (LiBF₄), lithium bis(oxalato)borate (LiBOB), or combinations thereof;
(d) optionally, one or more additives selected from the group consisting of:
i. fluoroethylene carbonate (FEC),
ii. vinylene carbonate (VC),
iii. ethylene carbonate (EC),
iv. lithium nitrate (LiNO₃),
v. tris(trimethylsilyl)phosphite (TMSP),
wherein the total volume of the first and second solvents is from 100 vol % ether to 100 vol % nitrile, and the electrolyte exhibits ionic conductivity sufficient to enable lithium-ion intercalation and deintercalation at −80° C.

2. The electrolyte composition of claim 1, wherein the volumetric ratio of nitrile to ether ranges from 1:99 to 99:1.

3. The electrolyte composition of claim 1, wherein the lithium salt, or a combination of salts, have a concentration in the range of 0.3 M to 5.0 M.

4. The electrolyte composition of claim 1, wherein the electrolyte remains liquid and maintains electrochemical performance from −120° C. to +70° C.

5. The electrolyte composition of claim 1, wherein the total additive content is in the range of 0.1 to 50 vol %, with each individual additive present in a concentration of 0.1 to 50 vol % or 0.1 to 20wt %, depending on solubility and function.

6. The electrolyte composition of claim 1, wherein the BN or other nitrile undergoes reductive decomposition to form Li₃N in the interfacial layer.

7. The electrolyte composition of claim 1, wherein the ether and nitrile solvents form a dual-solvation structure that modulates the coordination environment of Li⁺ ions, reducing desolvation energy and facilitating lithium-ion intercalation at low temperatures.

8. The electrolyte composition of claim 1, wherein the ratio of solvent donor numbers between the nitrile and ether is tuned to optimize Li⁺ solvation structure and minimize ion-pair aggregation.

9. The electrolyte composition of claim 1, wherein the electrolyte forms a solid electrolyte interphase (SEI) comprising LiF, Li₃N, and polymeric species derived from ether ring-opening, thereby enhancing low-temperature interfacial stability.

10. The electrolyte composition of claim 1, wherein the nitrile solvent participates in the formation of an inorganic-organic hybrid interphase containing Li₃N and C—N polymeric species that suppress dendrite growth.

11. An electrolyte composition for a lithium-ion battery, comprising:
(a) 1,3-dioxolane (DOL) as an ether solvent;
(b) butyronitrile (BN) as a nitrile solvent;
(c) lithium bis(trifluoromethanesulfonyl)imide (LiTFSI) as a lithium salt;
(d) fluoroethylene carbonate (FEC) as an additive; and
(e) tris(trimethylsilyl)phosphite (TMSP) as an additive;
wherein the electrolyte enables reversible lithiation and delithiation of a lithium-ion battery at −80° C.

12. The electrolyte composition of claim 11, wherein the volumetric ratio of BN to DOL is from 40:60 to 60:40.

13. The electrolyte composition of claim 11, wherein the lithium salt concentration is from 0.5 M to 1.5 M.

14. The electrolyte composition of claim 11, wherein FEC is present at about 10 vol % of the electrolyte.

15. The electrolyte composition of claim 11, wherein TMSP is present at about 2 wt % of the electrolyte.

16. The electrolyte composition of claim 11, wherein the electrolyte remains liquid and electrochemically stable across a temperature range of −80° C. to +50° C.

17. The electrolyte composition of claim 11, wherein the interfacial layer formed on at least one electrode comprises LiF, Li₃N, and polymeric ether domains, and has a thickness sufficient to provide ionic conductivity and mechanical elasticity without substantial impedance growth.

18. An electrolyte composition for a lithium-ion battery, comprising:
(a) a first solvent selected from the group consisting of ethers having a freezing point below −80° C.;
(b) a second solvent selected from the group consisting of nitriles having a dielectric constant greater than 15;
(c) a lithium salt selected from the group consisting of lithium bis(trifluoromethanesulfonyl)imide (LiTFSI), lithium bis(fluorosulfonyl)imide (LiFSI), lithium hexafluorophosphate (LiPF₆), lithium perchlorate (LiClO₄), lithium tetrafluoroborate (LiBF₄), and lithium bis(oxalato)borate (LiBOB); and
(d) optionally, one or more additives selected from the group consisting of fluoroethylene carbonate (FEC), vinylene carbonate (VC), lithium nitrate (LiNO₃), and tris(trimethylsilyl)phosphite (TMSP);
wherein the electrolyte provides ionic conductivity sufficient to enable reversible lithiation and delithiation of a lithium-ion battery at −80° C.

19. The electrolyte composition of claim 18, wherein the first solvent and the second solvent co-occupy a lithium-ion primary solvation shell to form a solvent-separated-ion-pair-rich solvation environment having a lithium-ion transport activation energy of less than 10 kJ mol⁻¹.

20. The electrolyte composition of claim 18, wherein the electrolyte forms an interfacial layer comprising LiF, Li₃N, and polymeric ether domains that is thin, ionically conductive, and mechanically elastic.

21. The electrolyte composition of claim 18, wherein the volumetric ratio of the first solvent to the second solvent is between 20:80 and 80:20.

22. The electrolyte composition of claim 18, wherein the lithium salt concentration is between 0.3 M and 2.0 M.

23. The electrolyte composition of claim 18, wherein the electrolyte remains liquid and electrochemically stable across a temperature range of −100° C. to +70° C.

24. The electrolyte composition of claim 18, wherein the coupled solvation-interphase design decouples ionic mobility from interfacial stability, thereby suppressing solid electrolyte interphase and cathode electrolyte interphase thickening during operation at −80° C.

25. A method of manufacturing an electrolyte composition for a lithium-ion battery, the method comprising:
(a) selecting a first solvent comprising an ether having a freezing point below −80° C;
(b) selecting a second solvent comprising a nitrile having a dielectric constant greater than 15;
(c) combining the first solvent and the second solvent in a predetermined volumetric ratio;
(d) dissolving a lithium salt selected from the group consisting of lithium bis(trifluoromethanesulfonyl)imide (LiTFSI), lithium bis(fluorosulfonyl)imide (LiFSI), lithium hexafluorophosphate (LiPF₆), lithium perchlorate (LiClO₄), lithium tetrafluoroborate (LiBF₄), and lithium bis(oxalato)borate (LiBOB) into the combined solvents; and
(e) optionally introducing one or more additives selected from the group consisting of fluoroethylene carbonate (FEC), vinylene carbonate (VC), lithium nitrate (LiNO₃), and tris(trimethylsilyl)phosphite (TMSP),
wherein the method yields an electrolyte composition providing ionic conductivity sufficient to enable reversible lithiation and delithiation of a lithium-ion battery at −80° C.

26. The method of claim 25, wherein the first solvent and the second solvent are combined in a volumetric ratio between 40:60 and 60:40.

27. The method of claim 25, wherein the lithium salt is incorporated at a concentration between 0.3 M and 2.0 M.

28. The method of claim 25, wherein the first solvent and the second solvent are combined to co-occupy a lithium-ion primary solvation shell and form a solvent-separated-ion-pair-rich solvation environment having a lithium-ion transport activation energy of less than 10 kJ mol⁻¹.

29. The method of claim 25, wherein the electrolyte composition formed by the method remains liquid and electrochemically stable across a temperature range of −100° C. to +70° C.

30. The method of claim 25, wherein the electrolyte composition formed by the method produces, upon cycling in a lithium-ion cell, an interfacial layer comprising LiF, Li₃N, and polymeric ether domains that is thin, ionically conductive, and mechanically elastic.

31. The method of claim 25, wherein the coupled solvation-interphase design produced by the method decouples ionic mobility from interfacial stability, thereby suppressing solid electrolyte interphase and cathode electrolyte interphase thickening during operation at −80° C.

32. The method of claim 25, wherein the first solvent comprises 1,3-dioxolane (DOL).

33. The method of claim 25, wherein the first solvent comprises a cyclic ether having a five-membered ring structure and a freezing point below −80° C.

34. The method of claim 25, wherein the second solvent comprises butyronitrile (BN) or a nitrile having a dielectric constant in the range of 15 to 30.
